(19) United States
(12) Patent Application Publication
(10) Pub. No.: US 2009/0097567 A1
(43) Pub. Date: Apr. 16, 2009

(54) ENCODING APPARATUS AND ENCODING METHOD

(75) Inventors: Yoshinori Shigeta, Kanagawa (JP); Hiromitsu Nakayama, Kanagawa (JP); Kiwamu Watanabe, Kanagawa (JP); Satoshi Takekawa, Kanagawa (JP); Tatsuhiro Suzumura, Kanagawa (JP); Takaya Ogawa, Kanagawa (JP); Masashi Jobashi, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/245,984

(22) Filed: Oct. 6, 2008

(30) Foreign Application Priority Data
Oct. 15, 2007 (JP) 2007-268206

(51) Int. Cl. H04N 7/12

(52) U.S. Cl. 375/240.24; 375/E07.076

(57) ABSTRACT

An encoding apparatus includes: an orthogonal transformation unit configured to orthogonally transform image data of a predetermined block size; a binarization unit configured to binarize the image data outputted from the orthogonal transformation unit; an arithmetic encoding unit configured to arithmetically encode the binary data generated by the binarization unit; and a prediction unit configured to predict, from the binary data, whether or not the amount of arithmetically encoded data generated by the arithmetic encoding unit exceeds a permissible maximum code amount based on a predetermined encoding standard. The encoding apparatus performs, when the prediction result is that the amount of arithmetically encoded data exceeds the maximum code amount, control to prevent the arithmetic encoding by the arithmetic encoding unit from being performed to the binary data corresponding to the prediction result.

### CROSS REFERENCE TO RELATED APPLICATIONS

This application is based upon and claims the benefit of priority from the prior Japanese Patent Application No. 2007-268206 filed on Oct. 15, 2007; entire contents of which are incorporated herein by reference.

### BACKGROUND OF THE INVENTION

1. Field of the Invention

The present invention relates to an encoding apparatus and an encoding method which perform moving image encoding based on the H.264 standard.

2. Description of the Related Art

As a recent standard for the compression encoding of images, there is the MPEG-4 Part10: Advanced Video Coding (MPEG-4AVC or H.264 standard (ITU-T H.264/AVC)) promulgated by the International Telecommunication Union Telecommunication Standardization Sector (ITU-T).

In an encoding apparatus of the H.264 standard (hereinafter abbreviated as H.264 encoding apparatus), a bit amount as a code amount permitted for each one macro block is restricted to a predetermined value or less, more specifically to 3200 bits or less on the basis of the standard.

For this reason, in the H.264 encoding apparatus, when the bit amount of one macro block exceeds 3200 bits at the time of performing arithmetic encoding, the corresponding macro block needs to be re-encoded as an I_PCM type macro block so that the macro block is converted into PCM (pulse code modulation) codes as digital codes without being compressed (hereinafter referred to as I_PCM re-encoding processing).

When the encoding processing of a plurality of macro blocks is performed in a pipeline manner, the pipeline processing has to be stopped for performing the I_PCM re-encoding processing. This causes the encoding processing efficiency to be reduced.

Note that Japanese Patent Application Laid-Open Publication No. 2005-203905 discloses a preceding example of an encoding apparatus which is capable of highly accurately estimating an amount of codes generated in encoding processing with many prediction modes prior to the encoding processing, and which is capable of controlling the encoding processing in encoding means and an encoding process, so as to optimize, for example, the image quality, compression ratio, and compression rate.

However, neither contents required for suppressing the code amount generated at the time of performing the arithmetic encoding to the permissible maximum code amount or less, nor contents required for mitigating the decrease in the encoding processing efficiency, are described in the preceding example.

For this reason, an encoding apparatus and an encoding method are desired which are able to reduce the frequency of the re-encoding or to eliminate the re-encoding in the case of the arithmetic encoding, and which are able to efficiently perform the encoding processing.

### SUMMARY OF THE INVENTION

An encoding apparatus according to one attitude of the present invention includes: an orthogonal transformation unit configured to orthogonally transform image data of a predetermined block size; a binarization unit configured to binarize the image data outputted from the orthogonal transformation unit; an arithmetic encoding unit configured to arithmetically encode the binary data generated by the binarization unit; and a prediction unit configured to predict, from the binary data, whether or not the arithmetically encoded data generated by the arithmetic encoding unit exceeds a maximum code amount permitted for the predetermined block size based on a predetermined encoding standard. The encoding apparatus is configured, when it is predicted by the prediction unit that the amount of the arithmetically encoded data exceeds the maximum code amount, to perform control so as to prevent the arithmetic encoding unit from arithmetically encoding the binary data corresponding to the prediction result.

An encoding apparatus according to another attitude of the present invention includes: an orthogonal transformation unit configured to orthogonally transform image data of a predetermined block size; a binarization unit configured to binarize the transformed data outputted from the orthogonal transformation unit; an arithmetic encoding unit configured to arithmetically encode the binary data generated by the binarization unit to generate arithmetically encoded data as a first encoded data of the image data; a digital code conversion unit configured to generate digital code data as a second encoded data of the image data by converting the image data into the digital code data, in parallel with the operation of the arithmetic encoding unit before the arithmetic encoding unit starts the operation to generate the arithmetically encoded data; a determination unit configured to determine whether or not the arithmetically encoded data generated by the arithmetic encoding unit exceeds a maximum code amount permitted for the predetermined block size based on a predetermined encoding standard; and a stream generation unit configured, when it is determined by the determination unit that the amount of arithmetically encoded data exceeds the maximum code amount, to select the digital code data converted by the digital code conversion unit as encoded data of the image data, to output a stream of the selected digital code data.

An encoding method according to one attitude of the present invention includes: orthogonally transforming image data of a predetermined block size; binarizing the image data formed by the orthogonal transformation; arithmetically encoding the binary data generated by the binarization; predicting, from the binary data, whether or not the amount of the arithmetically encoded data generated by the arithmetic encoding exceeds a maximum code amount permitted for the predetermined block size based on a predetermined encoding standard; performing, when it is predicted that the amount of arithmetically encoded data generated by the arithmetic encoding exceeds the maximum code amount, control to prevent the arithmetic encoding of the binary data corresponding to the prediction result.

### BRIEF DESCRIPTION OF THE DRAWINGS

FIG. 1 is a block diagram showing a configuration of an H.264 encoding apparatus according to a first embodiment of the present invention;

FIG. 2 is a block diagram showing a configuration of an H.264 encoding apparatus according to a modification of the first embodiment;

FIG. 3 is a flow chart showing a configuration of an H.264 encoding method according to the modification of the first embodiment;

FIG. 4 is a block diagram showing a configuration of an H.264 encoding apparatus according to a second embodiment of the present invention; and

FIG. 5 is a block diagram showing a configuration of an H.264 encoding apparatus of a reference example of the present invention.

### DETAILED DESCRIPTION OF THE PREFERRED EMBODIMENTS

### First Embodiment

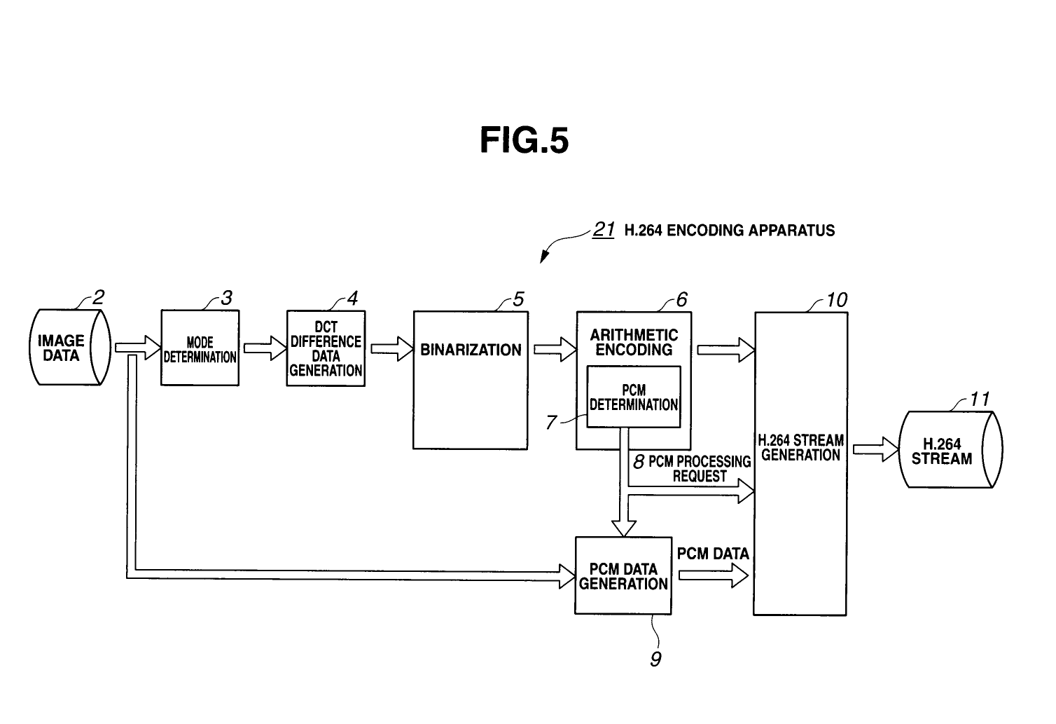

In the following, before describing an embodiment of the present invention, a reference example related to the present embodiment will be described. FIG. 5 shows a configuration of an H.264 encoding apparatus 21 of the reference example.

In the H.264 encoding apparatus 21, a mode determination unit 3 reads macro block image data 2 having a predetermined block size, and determines a macro block type by evaluating prediction modes in inter-picture encoding and intra-picture encoding. The contents related to the mode determination unit 3 are described in section 8.3 and section 8.4 of the following document. The prediction in the intra-picture encoding and the inter-picture encoding are described in section 8.3 and section 8.4, respectively.

ITU-T Recommendation H.264 (05/2003) “Advanced video coding for generic audiovisual services” (2003)

The data of the macro block type determined by the mode determination unit 3 are inputted, for example, into the DCT (discrete cosine transform) data generation unit 4 as an orthogonal transformation unit which performs orthogonal transformation.

Next, according to the determined macro block type, the DCT data generation unit 4 calculates difference data of the image data, performs DCT transformation of the difference data, and generates DCT difference data. The DCT difference data are inputted into a binarization unit 5. The contents related to the DCT data generation unit 4 are described in section 8.5 of the above described document.

The binarization unit 5 binarizes the macro block type data and the DCT difference data to generate binary data. The binary data are inputted into an arithmetic encoding unit 6. The contents related to the binarization unit 5 are described in section 9.3.2 of the above described document.

The arithmetic encoding unit 6 arithmetically encodes the binary data to generate arithmetically encoded data. The contents related to the arithmetic encoding unit 6 are described in section 9.3 of the above described document.

The arithmetic encoding unit 6 includes a PCM determination unit 7 as a determination unit configured to determine whether or not the amount of arithmetically encoded data per one macro block exceeds 3200 bits permitted as the maximum code amount.

Then, when detecting that the amount of arithmetically encoded data exceeds 3200 bits in the course of the arithmetic encoding processing, the PCM determination unit 7 interrupts the processing being performed by the arithmetic encoding unit 6. Then, the PCM determination unit 7 outputs a PCM processing request 8 to a PCM data generation unit 9 and an H.264 stream generation unit 10, so as to enable I_PCM re-encoding processing to be performed.

That is, as the I_PCM re-encoding processing, the PCM determination unit 7 forcibly rewrites the corresponding macro block type to I_PCM, while the arithmetic encoding unit 6 arithmetically encodes only the macro block type data, to generate macro block type arithmetically encoded data. The macro block type arithmetically encoded data are outputted to the H.264 stream generation unit 10.

When there is the PCM processing request 8, the PCM data generation unit 9 applies digital code conversion to the corresponding macro block image data 2, for example, pulse code modulation (PCM) encoding, and generates PCM data. Then, the PCM data generation unit 9 outputs the PCM data to the H.264 stream generation unit 10. The contents related to the PCM data generation unit 9 are described in section 8.3.4 of the above described document.

When there is not the PCM processing request 8, the H.264 stream generation unit 10 outputs the arithmetically encoded data as an H.264 stream 11. On the other hand, when there is the PCM processing request 8, the H.264 stream generation unit 10 generates the H.264 streams 11 by connecting the macro block type arithmetically encoded data and the PCM data, and outputs the connected data (that is, the macro block type arithmetically encoded data and the PCM data).

As described above, in the H.264 encoding apparatus 21 of the reference example, when detecting in the course of the arithmetic encoding processing that the amount of the arithmetically encoded data exceeds 3200 bits, the PCM determination unit 7 needs to interrupt the arithmetic encoding processing, so as to perform the I_PCM re-encoding processing.

In the case where the H.264 encoding apparatus 21 is configured to perform the pipeline type processing (also referred to as pipeline processing) to a plurality of macro blocks, the H.264 encoding apparatus 21 has a disadvantage that the pipeline processing is stopped while the I_PCM re-encoding processing is performed, thereby causing the processing efficiency of the H. 264 encoding processing to be reduced.

Here, the pipeline processing means an operation which enables the mode determination unit 3, the DCT data generation unit 4, the binarization unit 5, the arithmetic encoding unit 6, and the H.264 stream generation unit 10 to respectively perform processing simultaneously for the respective macro blocks which are different from each other (in regions).

Therefore, in the case where the arithmetic encoding processing is interrupted for image data of a certain macro block in the arithmetic encoding unit 6, even when the binary data are outputted to the arithmetic encoding unit 6 by the binarization unit 5 in the preceding stage, the arithmetic encoding processing of the image data of the preceding macro block is interrupted, and hence the processing cannot be promptly continued.

Therefore, an H.264 encoding apparatus is described which is able to mitigate or eliminate the above described decrease in the processing efficiency of the H.264 encoding processing and to smoothly generate the H.264 stream 11.

Next, an H.264 encoding apparatus is described which is able to clear the disadvantage of the reference example.

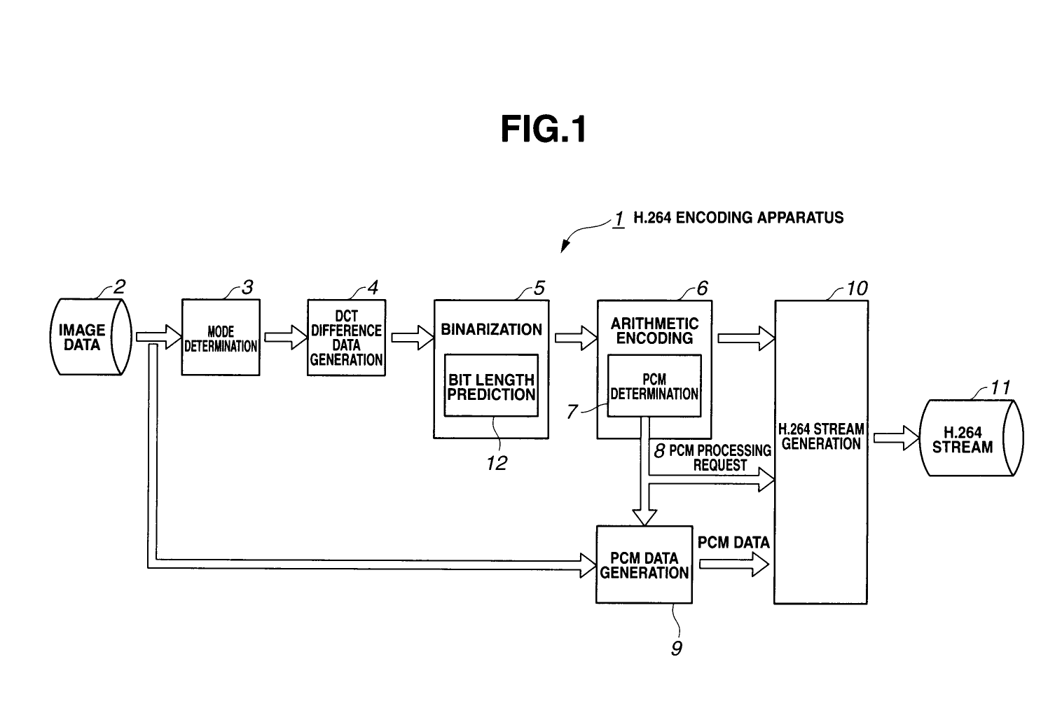

FIG. 1 shows a configuration of an H.264 encoding apparatus 1 according to a first embodiment of the present invention. The H.264 encoding apparatus 1 is fundamentally configured such that a bit length prediction unit 12 as will be described below is included in the H.264 encoding apparatus 21 shown in FIG. 5.

Then, before the arithmetic encoding unit 6 generates the arithmetically encoded data, the bit length prediction unit 12 predicts from the binary data of the binarization unit 5 whether or not the amount of the arithmetically encoded data exceeds 3200 bits which is the permissible maximum code amount based on the H.264 encoding standard. In the following, will be described a configuration and an operation of the H.264 encoding apparatus 1 including the bit length prediction unit 12.

The H.264 encoding apparatus 1 includes the mode determination unit 3 configured to read the inputted macro block image data 2.

The mode determination unit 3 evaluates prediction modes in inter-picture encoding (inter encoding) and intra-picture encoding (intra coding) for the read macro block image data 2, determines a macro block type, and outputs the data of the macro block type to the DCT data generation unit 4. The contents related to the mode determination unit 3 are described in section 8.3 and section 8.4 of the above described document.

The DCT data generation unit 4 calculates difference data of the image data 2 according to the determined macro block type and performs the DCT transformation of the difference data. Then, the DCT data generation unit 4 generates DCT difference data by the DCT transformation and outputs the DCT difference data to the binarization unit 5. The contents related to the DCT data generation unit 4 are described in section 8.5 of the above described document.

The binarization unit 5 binarizes the DCT difference data. The contents related to the binarization unit 5 are described in section 9.3.2 of the above described document, similarly to the case of the reference example.

In the H.264 encoding apparatus 1, the bit length prediction unit 12 is provided, for example, in the binarization unit 5, unlike the configuration of the reference example.

The binarization unit 5 in the present embodiment outputs the binarized DCT difference data as binarized binary data to the bit length prediction unit 12 in the binarization unit 5.

Further, the binarization unit 5 binarizes the macro block type data and generates binarized macro block type data (or macro block type binary data).

Before the arithmetic encoding is started, the bit length prediction unit 12 predicts whether or not the bit amount after the arithmetic encoding performed by the arithmetic encoding unit 6 exceeds 3200 bits, on the basis of the amount of the binary data of the inputted DCT difference data. In this specification, the prediction is referred to as bit length prediction.

Further, when the bit length prediction is that the bit amount exceeds 3200 bits, the bit length prediction unit 12 forcibly converts the corresponding macro block type into I_PCM.

The bit length prediction unit 12 performs the bit length prediction by a simple calculation based on the following Formula 1 utilizing a correlation between the bit amount of the binarized DCT difference data and the bit amount of the arithmetically encoded data formed by arithmetically encoding the binarized DCT difference data.

Bit amount of binarized DCT difference data*N>3200 (Formula 1)

Here, N is a numerical value of 1 or less, and is usually set to a value of about 0.8 to 0.6. In this way, in the present embodiment, the bit length prediction is performed by simply multiplying the bit amount of the binarized DCT difference data by a predetermined numerical value. Note that Formula I can also be expressed by a division form.

Thus, when Formula 1 is established as a result of the bit length prediction, the macro block type is forcibly converted to I_PCM, as described above.

Note that the bit length prediction unit 12 performs the bit length prediction to determine whether or not the bit length after the arithmetic encoding exceeds 3200 bits, on the basis of the bit amount of the binarized DCT difference data by using Formula 1, but the bit length prediction may also be performed on the basis of the sum of the bit amount of the binarized DCT difference data, and the bit amount of the corresponding binarized macro block type data (or macro block type binary data).

Then, when as a result of the bit length prediction by the bit length prediction unit 12 it is predicted that the bit length after the arithmetic encoding exceeds 3200 bits, control is performed in such a way that the arithmetic encoding of the binarized DCT difference data, which is performed at the time when the bit length prediction is not performed, is prevented from being performed in the arithmetic encoding unit 6. In this case, the arithmetic encoding unit 6 performs the arithmetic encoding of the I_PCM macro block type binary data.

In the present embodiment, when as a result of the bit length prediction by the bit length prediction unit 12 it is predicted that Formula 1 is established, the control of arithmetic encoding is performed in such a way that the macro block type is forcibly converted into I_PCM as described above, and that the result is outputted to the arithmetic encoding unit 6 (by the binarization unit 5 or the bit length prediction unit 12).

On the other hand, when as a result of the bit length prediction by the bit length prediction unit 12 it is predicted that the bit length after the arithmetic encoding does not exceed 3200 bits, the binarization unit 5 outputs binary data formed by connecting the binary data of DCT difference data, and the macro block type binary data to the arithmetic encoding unit 6, similarly to the case of FIG. 5. Then, the processing the same as that in the case of FIG. 5 will be performed as follows.

The arithmetic encoding unit 6 arithmetically encodes the binary data and generates arithmetically encoded data. Further, the arithmetic encoding unit 6 includes the PCM determination unit 7 configured to determine whether or not the bit amount of the arithmetically encoded data generated by the arithmetic encoding unit 6 exceed 3200 bits. The contents related to the arithmetic encoding unit 6 are described in section 9.3 of the above described document.

As described in the configuration shown in FIG. 5, when detecting in the course of the arithmetic encoding processing that the bit amount of the arithmetically encoded data exceeds 3200 bits, the PCM determination unit 7 interrupts the processing of the arithmetic encoding unit 6.

Then, the PCM determination unit 7 outputs the PCM processing request 8 to the PCM data generation unit 9 and the H.264 stream generation unit 10, so as to enable the I_PCM re-encoding processing to be performed.

In this case, the PCM determination unit 7 forcibly rewrites, as the I_PCM re-encoding processing, the macro block type to I_PCM.

Further, the arithmetic encoding unit 6 arithmetically encodes only the macro block type data and generates macro block type arithmetically encoded data. The macro block type arithmetically encoded data are outputted to the H.264 stream generation unit 10.

When there is the PCM processing request 8, the PCM data generation unit 9 applies digital code conversion to the corresponding macro block image data 2, for example, the pulse code modulation (PCM) encoding, and generates PCM data.

Then, the PCM data generation unit 9 outputs the generated PCM data to the H.264 stream generation unit 10. The contents related to the PCM data generation unit 9 are described in section 8.3.4 of the above described document.

When there is not the PCM processing request 8, the H.264 stream generation unit 10 outputs the arithmetically encoded data as the H.264 stream 11.

On the other hand, when there is the PCM processing request 8, the H.264 stream generation unit 10 connects the macro block type arithmetically encoded data and the PCM data to generate the H.264 stream 11, and outputs the connected data (that is, the macro block type arithmetically encoded data and the PCM data).

On the other hand, when the bit length prediction is that the bit amount of the arithmetically encoded data exceeds 3200 bits, the bit length prediction unit 12 forcibly converts the corresponding macro block type to I_PCM. Further, the binarization unit 5 generates binary data of the macro block type.

Then, when the binary data, the macro block type of which is forcibly converted to I_PCM, are inputted into the arithmetic encoding unit 6 from the binarization unit 5, the PCM determination unit 7 of the arithmetic encoding unit 6 immediately outputs the PCM processing request 8, without performing the normal PCM determination processing.

Further, the arithmetic encoding unit 6 performs only the arithmetic encoding of the macro block type binary data and outputs the generated arithmetically encoded data to the H.264 stream generation unit 10.

That is, in this case, the arithmetic encoding unit 6 does not perform the arithmetic encoding of the binarized DCT difference data.

Further, the PCM data generation unit 9, into which the PCM processing request 8 is inputted, performs the PCM encoding of the corresponding macro block image data 2 and outputs the generated PCM data to the H.264 stream generation unit 10.

On the basis of the PCM processing request 8, the H.264 stream generation unit 10 outputs the macro block type arithmetically encoded data generated by the arithmetic encoding unit 6 and the PCM data generated by the PCM data generation unit 9, as the H.264 stream 11, to the subsequent stage side.

In the case where the bit length prediction unit 12 performs the bit length prediction by using the bit amount of binarized DCT difference data in this way and where the predicted value of the bit length exceeds 3200 bits, the bit length prediction unit 12 performs control to prevent the corresponding binarized DCT difference data from being arithmetically encoded in the arithmetic encoding unit 6.

Therefore, the DCT difference data which are inputted into the arithmetic encoding unit 6 and which are arithmetically encoded by the arithmetic encoding unit 6 are limited to only the data having a bit amount predicted to be 3200 bits or less. Thus, according to the present embodiment, it is possible to reduce the frequency at which the I_PCM re-encoding processing is generated at the time when the arithmetic encoding is performed by the arithmetic encoding unit 6.

Further, the frequency of generation of the I_PCM re-encoding processing can be reduced, and hence when the H.264 encoding apparatus 1 is performing the pipeline processing to a plurality of macro blocks, it is possible to reduce the frequency at which the pipeline processing is stopped due to the I_PCM re-encoding processing.

Therefore, according to the present embodiment, it is possible to mitigate the decrease in the H.264 encoding processing efficiency.

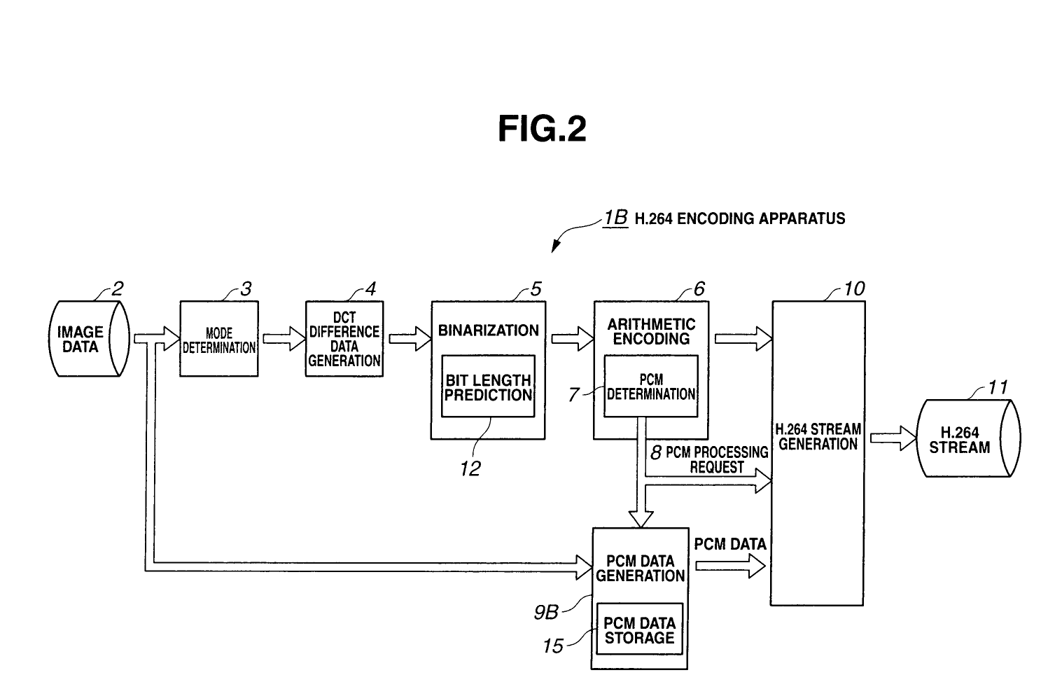

FIG. 2 shows a configuration of an H.264 encoding apparatus 1B according to a modification of the present embodiment.

The H.264 encoding apparatus 1B has a configuration in which a PCM data generation unit 9B is adopted instead of the PCM data generation unit 9 in FIG. 1.

The PCM data generation unit 9 in the H.264 encoding apparatus 1 shown in FIG. 1 is configured, when the PCM processing request 8 is generated, to generate PCM data of the corresponding macro block image data.

The PCM data generation unit 9B in the present modification is configured, even when the PCM processing request 8 is not generated, to generate the PCM data of macro block image data independently of or in parallel with the arithmetic encoding unit 6 side, and stores the generated PCM data, for example, in a PCM data storage unit 16 configured by a buffer memory, and the like, in the PCM data generation unit 9B.

In other words, before the PCM processing request 8 is generated, the PCM data generation unit 9B (serving as a digital code conversion unit) beforehand generates PCM data of the macro block image data to be generated at the time when the PCM processing request 8 is generated, and stores the generated PCM data in the PCM data storage unit 16 serving as PCM data temporary storage means.

Then, when it is predicted by the bit length prediction unit 12 that the predicted value of the bit length exceeds 3200 bits, the PCM processing request 8 is immediately issued by the PCM determination unit 7 on the basis of the prediction result (similarly to the above described embodiment). When the PCM processing request 8 is issued, the PCM data generation unit 9B reads the corresponding PCM data from the PCM data storage unit 16, and outputs the read PCM data to the H.264 stream generation unit 10.

Thereby, the PCM data can be outputted to the H.264 stream generation unit 10 in a shorter time, as compared with the case where the PCM data starts to be generated after the PCM processing request 8 is issued.

Further, in the case where it is predicted by the bit length prediction unit 12 that the predicted value of the bit length does not exceed 3200 bits, and also when it is determined by the PCM determination unit 7 that the bit amount of the arithmetically encoded data generated by the arithmetic encoding unit 6 exceeds 3200 bits, the PCM processing request 8 is inputted into the PCM data generation unit 9B.

Also in this case, the PCM data generation unit 9B reads the corresponding PCM data from the PCM data storage unit 16, and outputs the read PCM data to the H.264 stream generation unit 10.

Thereby, the PCM data can be outputted to the H.264 stream generation unit 10 in a shorter time, as compared with the case where the PCM data starts to be generated after the PCM processing request 8 is issued. That is, it is possible to sufficiently reduce the time period during which the arithmetic encoding processing of the arithmetic encoding unit 6 is interrupted.

As described above, in the present modification, when the PCM processing request 8 is issued, the corresponding PCM data can be promptly outputted to the H.264 stream generation unit 10. The other operations are the same as those of the case shown in FIG. 1.

According to the present modification, it is possible, similarly to the case of the first embodiment, to reduce the frequency at which the arithmetic encoding processing of the arithmetic encoding unit 6 is interrupted, and further, even when the arithmetic encoding processing is interrupted, it is possible to complete the interruption in a short period of time.

As a result, it is possible to further mitigate the decrease in the H.264 encoding processing efficiency as compared with the case of the first embodiment.

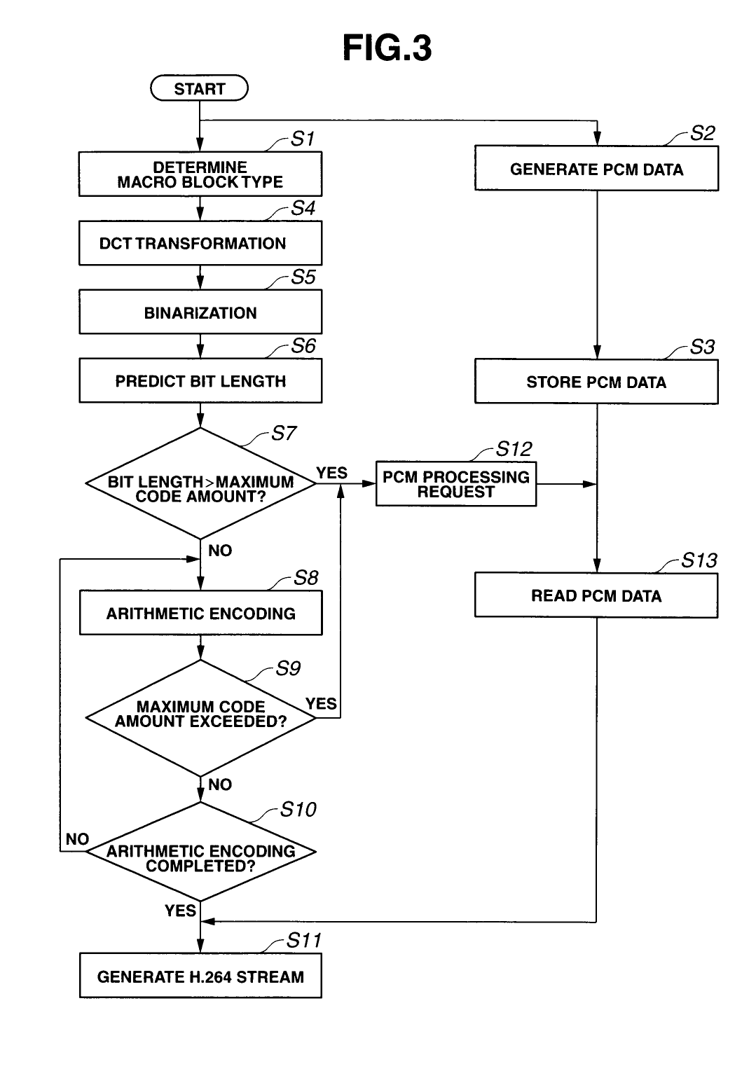

FIG. 3 shows a flow chart of a processing procedure in an encoding method according to the modification shown in FIG. 2. When the encoding method is started, as shown in step S1, the mode determination unit 3 evaluates two encoding prediction modes for the macro block image data 2 and determines a macro block type of the image data.

Further, as shown in step S2, the PCM data generation unit 9B starts the processing to generate the PCM data of the macro block image data 2 in parallel with step S1. Then, as shown in step S3, the generated PCM data are stored in the PCM data storage unit 16.

Note that the generation of the PCM data of the macro block image data 2 by the PCM data generation unit 9B is not limited to the case of being started in parallel with step SI, but may also be performed, for example, before the bit length prediction unit 12 performs the bit length prediction, or before the arithmetic encoding unit 6 starts the arithmetic encoding of the same (binarized) macro block image data 2.

On the other hand, according to the macro block determined in step SI, the DCT data generation unit 4 performs the DCT transformation of the difference data of the image data in step S4. Then, the DCT data generation unit 4 generates DCT difference data.

In subsequent step S5, the binarization unit 5 binarizes the DCT difference data generated in step S4. Also, the binarization unit 5 binarizes the macro block type.

Further, in subsequent step S6, the bit length prediction unit 12 in the binarization unit performs bit length prediction for the binarized DCT difference data. Then, in subsequent step S7, the bit length prediction unit 12 determines whether or not the bit length of the bit length prediction result exceeds the permissible maximum code amount based on the standard (simply described as the maximum code amount in FIG. 3).

When the determination is that the bit length of the prediction result does not exceed the maximum code amount, the arithmetic encoding unit 6 starts, in subsequent step S8, the arithmetic encoding of the binarized DCT difference data (connected with the binarized macro block type data).

When starting the arithmetic encoding, the arithmetic encoding unit 6 determines, during the arithmetic encoding as shown in step S9, whether or not the amount of arithmetically encoded data exceeds the maximum code amount. Then, when the amount of arithmetically encoded data does not exceed the maximum code amount, the arithmetic encoding unit 6 further determines, as shown in step S10, whether or not the arithmetic encoding is completed. When arithmetic encoding is not completed, the arithmetic encoding unit 6 continues the arithmetic encoding.

When completing the arithmetic encoding in this way, the arithmetic encoding unit 6 outputs the arithmetically encoded data to the H.264 stream generation unit 10. Then, as shown in step S11, the H.264 stream generation unit 10 outputs the H.264 stream 11.

On the other hand, when determining in the determination in step S7 that the bit amount of the prediction result exceeds the maximum code amount, the bit length prediction unit 12 enables the PCM determination unit 7 to output the PCM processing request to the PCM data generation unit 9B, as shown in step S12.

The PCM data generation unit 9B has generated the PCM data in parallel with the processing in step S1, and hence, reads, as shown in step S13, the PCM data corresponding to the PCM processing request from the PCM data storage unit 15 in a short period of time, and outputs the read PCM data to the H.264 stream generation unit 10.

Further, in step S9, the amount of arithmetically encoded data may also exceed the maximum code amount during the arithmetic encoding.

In this case, the PCM determination unit 7 outputs the PCM processing request to the PCM data generation unit 9B. Then, the processing of step S13 is performed as described above.

### Second Embodiment

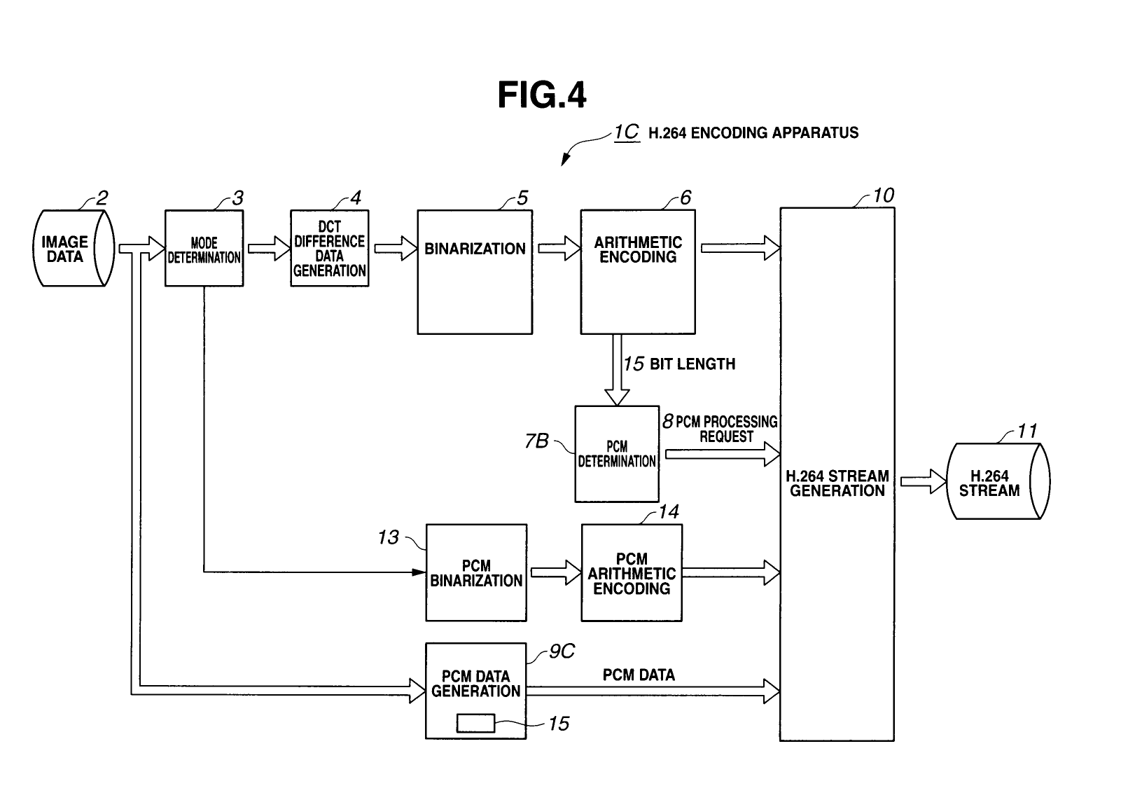

FIG. 4 shows a configuration of an H.264 encoding apparatus IC according to a second embodiment of the present invention. The H.264 encoding apparatus 1C is fundamentally configured such that the H.264 encoding apparatus 21 shown in FIG. 5 includes a PCM data generation unit 9C which is always used to generate the PCM data, in place of the PCM data generation unit 9 which is made to operate at the time when the PCM processing request 8 is generated, and includes a PCM binarization unit 13, and a PCM arithmetic encoding unit 14.

Thus, the PCM data generation unit 9C generates the PCM data from the macro block image data 2, and outputs the generated PCM data to the H.264 stream generation unit 10.

Further, in correspondence with the PCM data generated by the PCM data generation unit 9C, the PCM binarization unit 13 binarizes the macro block type determined by the mode determination unit 3 to I_PCM and generates binarized macro block type data. Then, the PCM binarization unit 13 outputs the binarized macro block type data to the PCM arithmetic encoding unit 14.

The PCM arithmetic encoding unit 14 arithmetically encodes the binarized macro block type data and generates PCM arithmetically encoded data. Then, the PCM arithmetic encoding unit 14 outputs the PCM arithmetically encoded data to the H.264 stream generation unit 10.

Further, in FIG. 5, the PCM determination unit 7 is provided in the arithmetic encoding unit 6, and determines whether or not the bit amount of the arithmetically encoded data exceeds 3200 bits. When determining that the bit amount of the arithmetically encoded data exceeds 3200 bits, the PCM determination unit 7 outputs the PCM processing request 8 to the H.264 stream generation unit 10 and the PCM data generation unit 9. On the other hand, the PCM determination unit 7B in the present embodiment is provided, for example, in the outside of the arithmetic encoding unit 6, and receives a bit length 15 of the arithmetically encoded data from the arithmetic encoding unit 6.

The PCM determination unit 7B is also configured to output the PCM processing request 8 to the H.264 stream generation unit 10 at the time when determining that the bit length 15 of the arithmetically encoded data exceeds 3200 bits.

Further, the arithmetically encoded data generated by the arithmetic encoding unit 6 are inputted into the H.264 stream generation unit 10.

Note that in the present embodiment, the arithmetic encoding unit 6 is configured so as not to interrupt (or not to need to interrupt) the processing of the arithmetic encoding even at the time when the PCM determination unit 7B outputs the PCM processing request 8.

When the PCM processing request 8 is not inputted from the PCM determination unit 7B, the H.264 stream generation unit 10 selects the arithmetically encoded data inputted from the arithmetic encoding unit 6 and outputs the selected data as the H.264 stream 11.

On the other hand, when the PCM processing request 8 is inputted from the PCM determination unit 7B, the H.264 stream generation unit 10 connects the PCM data inputted from the PCM data generation unit 9C and the PCM arithmetically encoded data inputted from the PCM arithmetic encoding unit 14 and outputs the connected data as the H.264 stream 11.

Note that the PCM data generation unit 9C stores in the PCM data storage unit 15 the PCM data generated similarly to the PCM data generation unit 9B shown in FIG. 2. Thus, when the PCM determination unit 7B outputs the PCM processing request 8, the stored PCM data are outputted to the H.264 stream generation unit 10.

It may also be configured such that the PCM data are stored in the H.264 stream generation unit 10, instead of providing the PCM data storage unit 15 in the PCM data generation unit 9C.

Further, the PCM arithmetic encoding unit 14 may also be configured to include a PCM arithmetically encoded data storage unit for storing the generated PCM arithmetically encoded data.

The other configuration and operations are similar to those of the H.264 encoding apparatus 21 shown in FIG. 5. In the present embodiment, according to the mode determination result by the mode determination unit 3, the DCT data generation unit 4, the binarization unit 5, and the arithmetic encoding unit 6 respectively perform operations in a pipeline manner for the determined macro block type image data.

In parallel with the above operations, the PCM data generation unit 9C switches the macro block type to I_PCM, and generates PCM data from the image data of the macro block.

Note that the timing, at which the PCM data generation unit 9C generates the PCM data, is not limited to the case of being set in parallel with the timing at which the mode determination unit 3 shown in FIG. 4 performs the mode determination, but may be set, for example, before the arithmetic encoding unit 6 starts the arithmetic encoding of the same (but binarized) image data.

Further, the PCM binarization unit 13 binarizes the macro block type as I_PCM and generates binarized macro block type data. Then, the PCM binarization unit 13 outputs the binarized macro block type data to the PCM arithmetic encoding unit 14.

That is, it is configured such that for the common image data 2, in parallel with the first encoding operation performed on the arithmetic encoding unit 6 side, the second encoding operation is performed on the PCM data generation unit 9C side of the digital code conversion unit side.

Also, as described above, it is configured such that when the PCM processing request 8 is not inputted from the PCM determination unit 7B, the H.264 stream generation unit 1 0 selects the arithmetically encoded data from the arithmetic encoding unit 6 and outputs the selected data, and that on the contrary, when the PCM processing request 8 is inputted, the H.264 stream generation unit 10 selects the PCM data from the PCM data generation unit 9C side and the PCM arithmetically encoded data and outputs the selected data.

Further, it is configured such that even when it is determined by the PCM determination unit 7B that the PCM processing request 8 is issued, the arithmetic encoding unit 6 does not interrupt (in other words, does not need to interrupt) the arithmetic encoding processing.

Next, an operation of the H.264 encoding apparatus 21 according to the present embodiment will be described.

The mode determination unit 3 reads the macro block image data 2, evaluates prediction modes in inter-picture encoding or intra-picture encoding, and determines a macro block type.

Further, the macro block image data are also inputted into the PCM data generation unit 9C, and the PCM data are generated.

The DCT data generation unit 4 acquires the image difference data according to the macro block type determined by the mode determination unit 3, performs the DCT transformation of the image difference data, and generates the DCT difference data.

The binarization unit 5 binarizes the macro block type and the DCT difference data, and generates binary data.

The arithmetic encoding unit 6 arithmetically encodes the binary data and generates arithmetically encoded data. At this time, the arithmetic encoding unit 6 outputs, to the PCM determination unit 7B, the bit amount of the arithmetically encoded data as the bit length 15.

The PCM determination unit 7B determines whether or not the bit length 15 exceeds 3200 bits. When the bit length 15 exceeds 3200 bits, the PCM determination unit 7B outputs the PCM processing request 8 to the H.264 stream generation unit 10.

As described above, the PCM data generation unit 9C generates the PCM data of the macro block image data. Then, the PCM data generation unit 9C outputs the generated PCM data to the H.264 stream generation unit 10.

Further, the PCM binarization unit 13 binarizes the macro block type as I_PCM, generates binarized macro block type data, and outputs the generated data to the PCM arithmetic encoding unit 14. The PCM arithmetic encoding unit 14 arithmetically encodes the binarized macro block type data, generates PCM arithmetically encoded data, and outputs the generated data to the H.264 stream generation unit 10.

When there is not the PCM processing request 8, the H.264 stream generation unit 10 outputs the data inputted from the arithmetic encoding unit 6 as an H.264 stream 11. When there is the PCM processing request 8, the H.264 stream generation unit 10 connects the PCM arithmetically encoded data and the PCM data, and outputs the connected data as an H.264 stream 11.

According to the present embodiment, even when there occurs a state in which the amount of the arithmetically encoded data generated by the arithmetic encoding unit 6 exceeds 3200 bits which is the permissible maximum code amount based on the standard, it is possible to output to the H.264 stream generation unit 10 the PCM data generated in parallel with the arithmetic encoding processing.

Therefore, since the arithmetic encoding unit 6 does not need to interrupt the arithmetic encoding processing, it is possible to prevent the decrease in the efficiency of the H.264 encoding processing.

Therefore, according to the present embodiment, the pipeline processing is not need to be stopped, and hence the H.264 encoding processing can be efficiently performed.

Note that in the present embodiment, the PCM data generation unit 9B shown in FIG. 2 may also be adopted as the PCM data generation unit 9C.

Note that the present invention is not limited to the case of the H.264 encoding apparatus as described above, and can be widely applied in cases where the permissible maximum code amount based on the standard is specified.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An encoding apparatus comprising:
an orthogonal transformation unit configured to orthogonally transform image data of a predetermined block size;
a binarization unit configured to binarize the image data outputted from the orthogonal transformation unit;
an arithmetic encoding unit configured to arithmetically encode the binary data generated by the binarization unit; and
a prediction unit configured to predict, from the binary data, whether or not the amount of the arithmetically encoded data generated by the arithmetic encoding unit exceeds a maximum code amount permitted for the predetermined block size based on a predetermined encoding standard,
wherein when it is predicted by the prediction unit that the amount of arithmetically encoded data exceeds the maximum code amount, control is performed to prevent the arithmetic encoding by the arithmetic encoding unit from being performed to the binary data corresponding to the prediction result.

2. The encoding apparatus according to claim 1,
wherein the prediction unit performs the prediction by multiplying or dividing the data amount of the binary data by a predetermined parameter value.

3. The encoding apparatus according to claim 1, further comprising:
a digital code conversion unit configured to beforehand convert, to digital code data, image data corresponding to the binary data used for the prediction by the prediction unit; and
a storage section configured to store the digital code data generated by the digital code conversion unit.

4. The encoding apparatus according to claim 1,
wherein the orthogonal transformation unit, the binarization unit, and the arithmetic encoding unit are configured in a pipeline configuration in which processing of image data of a block size corresponding to each different area can be simultaneously performed.

5. The encoding apparatus according to claim 1,
wherein when it is predicted by the prediction unit that the amount of the arithmetically encoded data exceeds the maximum code amount, the prediction unit performs control to prevent the arithmetic encoding unit from arithmetically encoding the corresponding binary data, and issues a request for converting the image data corresponding to the binary data to digital code data.

6. The encoding apparatus according to claim 5, further comprising:
a digital code conversion unit configured, when the prediction unit issues the request, to convert, to the digital code data, the image data corresponding to the binary data corresponding to the request.

7. The encoding apparatus according to claim 6, further comprising:
a stream generation unit configured to select one of the arithmetically encoded data generated by the arithmetic encoding unit and the digital coded data generated by the digital code conversion unit, and configured to output the selected data as a stream based on a predetermined standard.

8. The encoding apparatus according to claim 1, further comprising:
a stream generation unit configured to select the arithmetically encoded data generated by the arithmetic encoding unit, and configured to output the selected data as a stream based on a predetermined standard.

9. The encoding apparatus according to claim 1,
wherein the digital code conversion unit is a PCM data generation unit configured to generate PCM data by pulse code modulation (PCM).

10. The encoding apparatus according to claim 1,
further configured to read image data of the predetermined block size, and to determine a macro block type at the time of encoding the image data, on the basis of prediction modes in inter-picture encoding and intra-picture encoding.

11. The encoding apparatus according to claim 1,
wherein the maximum code amount is a permissible maximum code amount based on the H.264 standard.

12. An encoding apparatus comprising:
an orthogonal transformation unit configured to orthogonally transform image data of a predetermined block size;
a binarization unit configured to binarize the transformed data outputted from the orthogonal transformation unit;
an arithmetic encoding unit configured to arithmetically encode the binary data generated by the binarization unit to generate arithmetically encoded data as a first encoded data of the image data;
a digital code conversion unit configured to generate digital code data as a second encoded data of the image data by converting the image data into the digital code data, in parallel with the operation of the arithmetic encoding unit before the arithmetic encoding unit starts to generate the arithmetically encoded data;
a determination unit configured to determine whether or not the amount of the arithmetically encoded data generated by the arithmetic encoding unit exceeds a maximum code amount permitted for the predetermined block size based on a predetermined encoding standard; and
a stream generation unit configured, when it is determined by the determination unit that the amount of arithmetically encoded data exceeds the maximum code amount, to select the digital code data converted by the digital code conversion unit as encoded data of the image data, to output the selected digital code data as a stream.

13. The encoding apparatus according to claim 12,
further configured to determine a macro block type at the time of encoding the image data, on the basis of prediction modes in inter-picture encoding and intra-picture encoding.

14. The encoding apparatus according to claim 12, further comprising:
a second binarization unit configured to binarize macro block type data at the time of performing encoding, which has been determined on the basis of prediction modes in inter-picture encoding and intra-picture encoding for the image data.

15. The encoding apparatus according to claim 12,
wherein the stream generation unit is configured, when it is determined that the amount of the arithmetically encoded data does not exceed the maximum code amount, to select the arithmetically encoded data generated by the arithmetic encoding unit, and to output the selected data as the stream.

16. The encoding apparatus according to claim 12,
wherein the orthogonal transformation unit, the binarization unit, and the arithmetic encoding unit are configured in a pipeline configuration in which processing of image data of a block size corresponding to each different area can be performed.

17. The encoding apparatus according to claim 12,
wherein the digital code conversion unit is a PCM data generation unit configured to generate PCM data by pulse code modulation (PCM).

18. An encoding method comprising:
orthogonally transforming image data of a predetermined block size;
binarizing the image data transformed by the orthogonal transformation;
arithmetically encoding the binary data generated by the binarization;
predicting, from the binary data, whether or not the amount of the arithmetically encoded data generated by the arithmetic encoding exceeds a maximum code amount permitted for the predetermined block size based on a predetermined encoding standard; and
performing, when it is predicted that the amount of arithmetically encoded data generated by the arithmetic encoding exceeds the maximum code amount, control to prevent the arithmetic encoding of the binary data corresponding to the prediction result.

19. The encoding method according to claim 18,
wherein the prediction to determine whether or not the amount of the binary data exceeds the permissible maximum code amount is performed by multiplying or dividing the data amount of the binary data by a predetermined parameter value.

20. The encoding method according to claim 18, further comprising:
starting processing for converting the image data into digital code data before the prediction is performed to determine whether or not the amount of the binary data exceeds the permissible maximum code amount.
